(19) United States
(12) Patent Application Publication
(10) Pub. No.: US 2026/0361093 A1
(43) Pub. Date: Nov. 12, 2026

(54) Generating Unit with Secure Grid Connection of an Asynchronous Machine

(71) Applicant: Orcan Energy AG, Munich (DE)

(72) Inventors: Alexander Zimmermann, Munich (DE); Ralf Schuchert, Schleid (DE); Lukas Kopf, Lechbruck am See (DE); Alexander Bischoff, Dachau (DE); Jens-Patrick Springer, Munich (DE)

(21) Appl. No.: 19/121,741

(22) PCT Filed: Oct. 11, 2023
(86) PCT No.: PCT/EP2023/078120

§ 371 Date: Apr. 16, 2025

(30) Foreign Application Priority Data
Oct. 18, 2022 (EP) 22202299.8

(51) Int. Cl. H02J 3/40; F01K 23/06; H02H 7/06; H02J 3/0012; H02J 3/38; H02P 3/04; H02P 101/20; H02P 103/10

(52) U.S. Cl. CPC H02J 3/40; F01K 23/065; H02H 7/06; H02J 3/0012; H02J 3/381; H02P 3/04; H02P 2101/20; H02P 2103/10

(57) ABSTRACT

A generating unit, GU, includes an asynchronous machine with a connecting branch for direct grid connection to a power grid and an energy converter that operates according to a thermodynamic or fluiddynamic process, in particular a thermodynamic cycle process, and thus drives the asynchronous machine for generating electricity. An excitation component is provided, which is formed from capacitors that are connected to the asynchronous machine for simple, secure and simple grid connection.

### TECHNICAL FIELD

The present invention relates to measures for simple, secure and simple grid connection of a generating unit with an asynchronous machine which is driven by an energy converter that operates according to a thermodynamic cycle process, and to a generating system composed of one or more of these generating units.

### TERMS AND DEFINITIONS

A generating unit (GU) is a machine that converts non-electrical energy into electrical energy.

A generating system (GS) is understood to be a system which contains one GU or several GUs as well as all electrical equipment required for operation. The electrical equipment required for operation can be, for example, transformers or logic control units programmable from memory for controlling the active and reactive power output of the individual GU(s) or of the GS.

A direct grid connection is understood to be a connection in which an asynchronous machine is connected to a power grid without a converter connected therebetween.

A direct connection is understood to be an electrical connection in which two electrical systems or electrical components are connected without power electronics or switching devices being connected therebetween.

### BACKGROUND OF THE INVENTION

Known thermodynamic or fluiddynamic processes, in particular thermodynamic cycle processes, are used to convert thermal or kinematic energy into electrical energy. In a thermodynamic cycle process, such as a Rankine cycle, a work fluid, typically water or, in the case of the Organic Rankine cycle, other working materials such as coolants, hydrocarbons, or silicone oils, is alternately vaporized in a closed circuit by the supply of heat at high pressure and after expansion, in which mechanical power is released, is condensed by removing heat at low pressure. The mechanical power obtained is converted by an electrical machine and fed into a power grid.

To maintain grid stability, variably excited synchronous machines or asynchronous machines with frequency converters are preferably used as electrical machines. An asynchronous machine with a frequency converter driven by the Organic Rankine cycle is known, for example, from EP 3940913 A1. However, these systems are relatively expensive and hardly competitive on the market, especially with comparatively low feed-in capacities. In addition, they are relatively maintenance-intensive and, in the case of asynchronous machines with frequency converters, are associated with losses due to the power electronics.

A known solution to counteract these drawbacks is to use the robustness of the power grid and to connect the asynchronous machine directly to the power grid, i.e. without a frequency converter. However, this approach poses a not inconsiderable problem in thermodynamic or fluiddynamic processes, in particular in thermodynamic cycle processes of the type mentioned above, since the residual energy contained in the process and its supply, which continues to flow for a short time after an emergency shutdown, can be dissipated only slowly.

In the event of an emergency shutdown of the generating unit, the braking effect exerted upon the rotor of the asynchronous machine is lost due to the field generated by the grid in the stator and the rotor, driven by the residual energy in the thermodynamic cycle process, can accelerate dangerously—high and even damage the asynchronous machine and the expansion machine connected. Likewise, when the generation unit is directly connected to the power grid, high start-up currents can arise, which cause the voltage in the grid to drop impermissibly. Furthermore, an asynchronous machine also draws inductive reactive power as a generator which, depending on the grid condition, has a voltage-changing effect or at least increases the strength of current without benefit.

The object of the invention is to provide a generating unit which overcomes the drawbacks mentioned.

### SUMMARY

According to a first aspect of the invention, a generating unit, GU, is provided which is an asynchronous machine with a connecting branch for direct grid connection to a power grid, an energy converter that operates according to a thermodynamic or fluiddynamic process, in particular a thermodynamic cycle process, and thus drives the asynchronous machine for generating electricity, and comprises an excitation component, where the excitation component is formed from capacitors that are connected to the asynchronous machine.

The capacitance of the capacitors can form an oscillating circuit with the inductance of the asynchronous machine which, through resonance, makes it possible to excite a sufficiently high voltage from the very small voltage induced in the stator by the rotor remanence. This can contribute to the magnetization of the asynchronous machine and prevent high start-up currents when connecting to the power grid in a synchronized manner. Furthermore, it prevents the rotor from revving up in the event of an uncontrolled shutdown, such as an emergency shutdown, of the GU or the asynchronous machine, respectively, since it can convert power at a c that has a braking effect.

The capacitors can be connected directly to the asynchronous machine, i.e. without power electronics or switching devices being connected therebetween.

Alternatively, the capacitors can be connected to the asynchronous machine via a switching device.

The power grid can be a public three-phase grid on land, preferably a low or medium voltage grid, or a ship electrical system.

The thermodynamic cycle process can be a Rankine cycle, preferably an Organic Rankine cycle.

The energy converter can be a Rankine Cycle machine, preferably an Organic Rankine cycle machine, with an expansion machine. The expansion machine can be mechanically coupled to a shaft of the asynchronous machine. Heat output, in particular waste heat, can be supplied to the Rankine Cycle machine for driving the expansion machine.

The asynchronous machine can be integrated into the expansion machine. The asynchronous machine can be a three-phase asynchronous machine with a short circuit rotor or squirrel-cage rotor.

The expansion machine and the asynchronous machine can be housed in a closable, i.e. semi-hermetic housing with one or more steam connections, in particular a steam inlet for live steam and a steam outlet for waste steam, and the electrical connection. The asynchronous machine can have a rated power of between 50 and 5000 kW, preferably between 100 and 2000 kW, in particular between 150 and 1000 kW.

The capacitors can be star-connected or delta-connected.

The GU can also comprise brake resistances which can be connected to the asynchronous machine via a brake resistance switching device. The brake resistances can be star-connected or delta-connected.

In the event of a shutdown, for example an emergency shutdown, of the GU from the grid, the brake resistances can convert the residual energy supplied by the thermodynamic or fluiddynamic process into thermal energy.

The brake resistance switching device can comprise operating contacts for connecting the brake resistances to the asynchronous machine or to disconnect the brake resistances from the asynchronous machine.

The operating contacts can be closing operating contacts for actively switching on the brake resistances.

Alternatively, the operating contacts can be opening operating contacts for actively switching off the brake resistances. This enables the operating contacts to be closed in the event of a failure of the control device or a failure of the control voltage supply, in order to securely brake the rotor of the asynchronous machine.

Alternatively, the brake resistance switching device can comprise closing operating contacts and an inverting element in its actuation and can therefore be actively switched off in order to securely brake the rotor of the asynchronous machine in the event of failure of the control device.

Furthermore, the GU can comprise a control unit for controlling the brake resistance switching device. The control unit can be configured to connect the brake resistances once or several times to the asynchronous machine based on a measured GU voltage when the GU is disconnected from the power grid, in particular in the event of an emergency shutdown of the GU, preferably at a point in time at which the measured GU voltage exceeds a limit value.

Furthermore, the GU can comprise a grid switching device such as a contactor, a circuit breaker, or a load-break switch for connecting or disconnecting the GU to/from the power grid and a control unit for controlling the grid switching device.

The control unit can be configured to synchronize the frequency of the asynchronous machine with the frequency of the power grid. For synchronization, the control unit can adjust the rotational speed of the asynchronous machine to the rotational speed of the power grid using the feed pump as an actuator.

The control unit can also be configured to connect the asynchronous machine synchronously to the power grid, preferably in that the control unit forms a differential voltage based on a measured grid voltage and a measured GU voltage and, based on this, connects the grid switching device, taking into account a pull-in time of the grid switching device and other significant delay times, for example, of coupling relays, below a limit value of the differential voltage, preferably at a voltage magnitude between 0 V and 150 V, in particular less than 100 V. The limit value can be the zero crossover of the differential voltage.

The control unit can be configured in particular to record the differential voltage over a time interval for synchronizing the connection in order to form a differential voltage profile, in particular a sinusoidal differential voltage profile, and to convert the differential voltage profile to an envelope, preferably using a regression model via the voltage maxima, in particular an envelope detector. The control unit can determine one or more properties of the envelope, such as a present gradient of the envelope and, determine a command point in time, based on the one or more properties and information about the grid switching device, in particular the pull-in time for closing its operating contacts, and other significant delay times, for example, of coupling relays, for transmitting a switch-on command to the grid switching device at which the differential voltage is below the limit value after the pull-in time has elapsed and can transmit the switch-on command at the command point in time to the grid switching device.

The energy converter can comprise an expansion machine and a vaporizer capable of vaporizing a work fluid with the heat output supplied and directing it into the expansion machine for conversion to mechanical power. Furthermore, the energy converter can comprise a feed pump, the rotational speed of which can be controlled and which can be configured to obtain the work fluid from the expansion machine, preferably from a condenser for liquefaction connected therebetween, and to convey it back to the vaporizer. The control unit can be configured to regulate or control the rotational speed of the feed pump, with which the pressure ratio of live steam is adjusted in relation to the pressure in the condenser, so that the rotational speed of the expansion machine is made to match the grid frequency or the grid rotational speed.

The GU can further comprise a second energy converter, preferably an internal combustion engine. The second energy converter can generate the waste heat which is fed to the first energy converter, in particular to the Rankine cycle machine or to the Organic Rankine cycle machine, for generating electricity.

The second energy converter can be operated with petroleum or petroleum derivatives, preferably methane or heavy oil, or with gases such as natural gas, landfill gas, sewage gas, mine gas, biogas, or hydrogen gas.

The second energy converter can also comprise and drive an electrical generator.

A generating system, GS, is provided according to a second aspect of the invention and comprises at least one GU according to the first aspect of the invention and is connected to a power grid for generating electricity. The power grid can be a public power grid on land or a ship electrical system.

The GS can also comprise a second GU which can be connected to the power grid in parallel with the first GU.

Furthermore, the GS can comprise a transformer with a low and high voltage side for direct connection to a grid connection point of the power grid. The first GU and the second GU can be connected in parallel to the low-voltage side of the transformer. Any voltage differences between the power grid and the GUs can be compensated for by the transformer connected therebetween and/or the GS grid can be isolated from the superordinate power grid, i.e. electrically separated.

### List of Abbreviations

GU generating unit
GS generation system
RC Rankine cycle (as a thermodynamic cycle process)
ORC Organic Rankine cycle

### FIGURES

Preferred embodiments of the invention shall be explained in more detail below with reference to the drawings, where:

FIG. 1 shows a schematic structure of a GU with an ORC machine as an energy converter according to a first embodiment of the invention;

FIG. 2 shows an exemplary voltage profile of a differential voltage between the power grid and the asynchronous machine with an indicator that indicates a preferred point in time for connecting the GU;

FIG. 3 shows a schematic control current circuit for synchronizing the frequency of the asynchronous machine to the power grid frequency for secure connection of the GU;

FIG. 4 shows a schematic structure of a GU with an ORC machine for utilizing the waste heat of an internal combustion engine according to a second embodiment of the invention; and

FIG. 5 shows a schematic structure of a GS with a feed into a grid with a higher voltage level comprising a large number of GUS.

### DESCRIPTION

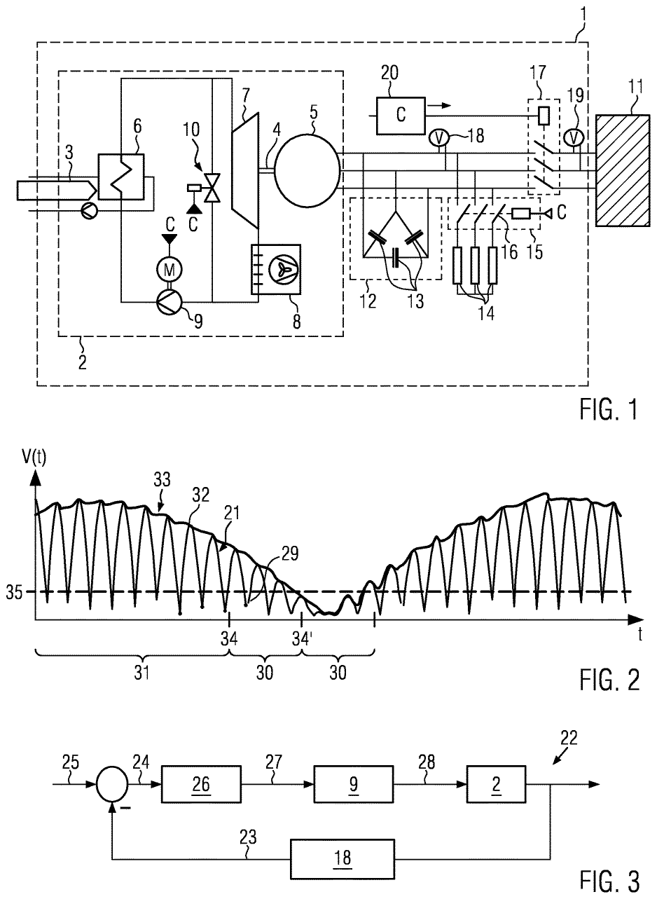

FIG. 1 shows a schematic structure of a GU 1 according to a first embodiment of the invention in which the energy converter is an ORC machine 2.

### I. GU with an ORC Machine

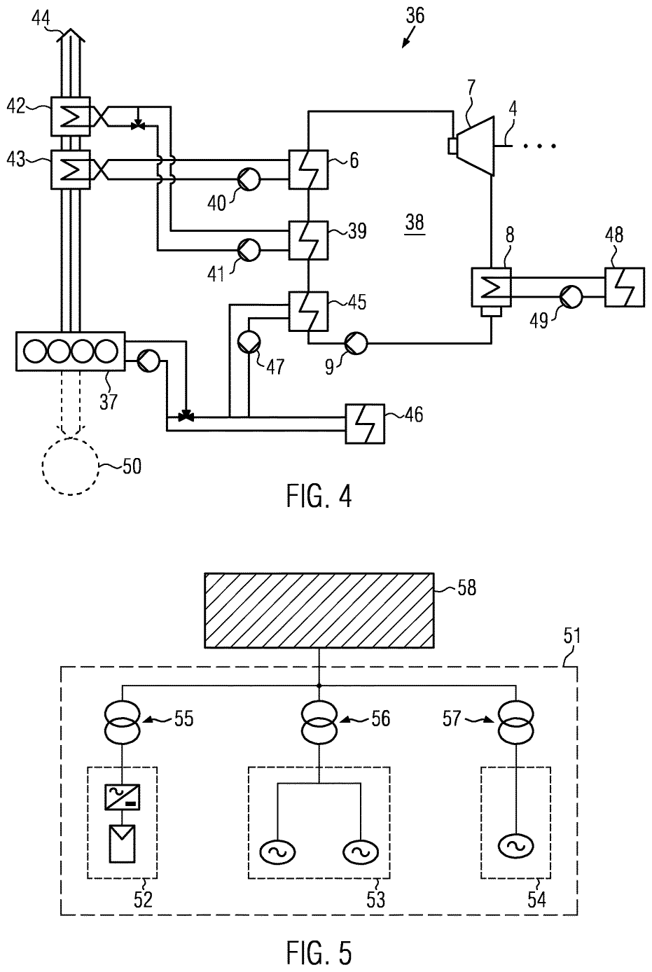

ORC machine 2 is supplied with heat output 3 which it converts into mechanical power and transmits via a shaft 4 to the rotor of an asynchronous machine 5. Heat output 3 can be supplied to ORC machine 2 from a heat source such as, for example, an internal combustion engine 37 shown in FIG. 4, via a heat transfer medium such as gas, steam, thermal oil, or water. A work fluid is vaporized there with a heat transferrer 6 (vaporizer) using heat output 3. The resulting live steam is then delivered to an expansion machine 7. The live steam is expanded in expansion machine 7 with the release of mechanical power which drives asynchronous machine 5 coupled to expansion machine 7. The vapor is subsequently condensed by removing heat using a condenser 8. A feed pump 9, which is operated (controlled or regulated) at a variable rotational speed, delivers the liquid work fluid back into vaporizer 6 where it is vaporized again. The cycle process is completed. The heat extracted by condenser 8 can be utilized as useful heat for subsequent processes. ORC machine 2 furthermore comprises a controllable bypass valve 10 for controlling, in particular reducing the pressure drop via expansion machine 7. Bypass valve 10 is activated by way of a control unit 20. Alternatively or additionally, bypass valve 10 can be switchable manually.

Asynchronous machine 5 is connected directly, i.e. without a frequency converter connected therebetween, via a connecting branch to a power grid 11 and feeds heat output 3 converted into electrical power into power grid 11, preferably a public three-phase grid or a ship electrical system. The connecting branch can consist of power lines, switches, contactors, relays, plug-in and/or soldered connections.

An excitation component 12 consisting of a capacitor block with at least one capacitor 13 for each phase is connected in parallel with asynchronous machine 5 and power supply system 11. In the embodiment shown, capacitors 13 are delta-connected. In other embodiments, capacitors 13 can be star-connected. Capacitors 13 themselves can in turn consist of series, parallel, or mixed connections of individual capacitors. Excitation component 12 can likewise also be connected in series with capacitors 13 between asynchronous machine 5 and power grid 11. Excitation component 12 generates a voltage at asynchronous machine 5, which is not yet connected to the power grid, and thus ensures its magnetization, as a result of which the start-up currents are reduced. With a voltage-synchronized grid connection (see Chapter II. GU grid connection) with a small difference between the generator voltage and the grid voltage, the start-up currents can be reduced in the magnitude by at least 80%, preferably 50%, compared to the connection of a corresponding generating unit without an excitation component 12. Furthermore, excitation component 12 provides for the compensation of the inductive reactive power reference of the asynchronous machine in grid-connected operation of GU 1, whereby the apparent current of GU 1 drops and the power grid is less loaded.

Brake resistances 14 are also connected in parallel to asynchronous machine 5 and to power grid 11 via a brake resistance switching device 15. In the embodiment shown, brake resistances 14 are star-connected. In other embodiments, brake resistances 14 can be delta-connected. Brake resistance switching device 15 has operating contacts 16 which, in the embodiment shown, are configured as closing contacts for actively switching on brake resistances 14. Alternatively, operating contacts 16 can be opening contacts for actively switching off the brake resistances. This makes it possible for the operating contacts 16 to be closed in the event of a failure of the control device or a failure of the control voltage supply, in order to securely brake the rotor of asynchronous machine 5.

Furthermore, GU 1 comprises a grid switching device 17, preferably a contactor, a circuit breaker, or a load-break switch, for connecting or disconnecting GU 1 to power grid 11. Grid switching device 17 is connected in series between asynchronous machine 5 and power grid 11.

Furthermore, GU 1 comprises two voltage measuring devices 18, 19 for measuring the GU voltage and the power grid voltage, preferably for calculating the differential voltage between GU 1 and power grid 11. Voltage measuring device 18 for measuring the GU voltage is disposed between asynchronous machine 5 and grid switching device 17. Voltage measuring device 19 for measuring the power grid voltage is disposed between grid switching device 17 and power grid 11. The differential voltage over grid switching device 17 can likewise be measured directly using only one voltage measuring device.

Furthermore, GU 1 comprises a locally or remotely arranged control unit 20 which is connected directly or via other elements such as connecting relays, connecting contactors, or optocouplers to brake resistance switching device 15 and grid switching device 17, in particular to their control contacts, in order to close or to open the respective operating contacts.

Control unit 20 can be a hard-wired programmable logic controller, a memory-programmable logic controller, a microcontroller or a conventional electronic circuit with analog and digital elements. The function is represented in a hard-wired programmable logic controller by “wiring and selection of signaling and switching devices”, in a memory-programmable logic controller and a microcontroller by software and in electronic circuits by the selection of components and their routing.

In addition, protective functions can also run on the controller. The functions can also be mapped to the control device already present in the system for controlling the ORC.

Furthermore, control unit 20 is connected to feed pump 9 and bypass valve 10 for controlling the pressure drop via expansion machine 7.

### II. GU Grid Connection

Before GU 1 is connected to power grid 11, the voltage of GU 1 is adjusted to power grid 11, i.e. synchronized, in order to prevent high start-up currents.

However, within a thermodynamic process such as the ORC, the rotational speed of expansion machine 7 cannot be controlled with the same accuracy as, for example, with an internal combustion engine, and in particular in smaller systems with a nominal output of less than 5000 kW, in which a steam regulator is preferably dispensed with, is also provided with relatively large rotational speed fluctuation. Furthermore, a voltage amplitude of asynchronous machine 5 cannot be adjusted when excited with non-switchable capacitor groups. It is frequency-dependent due to the resonance effect.

FIG. 2 shows an exemplary voltage profile of a differential voltage (as an absolute value) between power grid 11 and asynchronous machine 5 at a frequency difference of about 5 Hz between the GU voltage and the grid voltage.

In order to smoothly switch GU 1 to the power grid despite the challenges mentioned above, control unit 20 is configured to control the rotational speed of feed pump 9 and/or the opening of bypass valve 10 such that the rotational speed of the expansion machine is made to correspond to the grid frequency or grid rotational speed, i.e. is synchronized. For example, if feed pump 9 rotates faster, more live steam pressure is built up which results in a greater pressure ratio over expansion machine 7 and it therefore rotates faster. In one embodiment, GU 1 also comprises a steam control valve on the high-pressure side of expansion machine 7.

FIG. 3 shows a schematic control current circuit 22 for synchronizing the rotational speed of expansion machine 7 and thus of asynchronous machine 5 to the rotational speed or frequency of power grid 11. Such a regulation can be carried out by control unit 20. A frequency 23 of asynchronous machine 5 is there determined with voltage measuring device 18 based on the measured GU voltage. Based on the control deviation 24, in relation to frequency 25 of power grid 11, which is determined based on the measured grid voltage with voltage measuring device 19 or is permanently specified, rotational speed 27 of feed pump 9 is set by a control device 26, whereby pressure ratio 28 with live steam pressure/condensation pressure and thus the rotational speed or frequency of expansion machine 7 or asynchronous machine 5 is adjusted.

After the frequency of GU 1, as shown in FIG. 3, has been adjusted to that of power grid 11, a suitable point in time, which at best corresponds to a natural zero crossover 29 of differential voltage 21, is determined for the connection.

For this purpose, control unit 20 determines differential voltage 21 based on the power grid voltage measured and the GU voltage measured. Based on differential voltage 21, control unit 20 switches on grid switching device 17 when differential voltage 21 drops below a limit value 35, preferably at a voltage magnitude between 0 V up to 150 V, in particular less than 100 V.

In a preferred embodiment for controlling the connection (voltage-synchronized power grid connection), control unit 20 is configured to switch on GU 1 in a forward-looking manner, i.e. taking into account the available pull-in time 30 until the operating contacts of grid switching device 17 close. For this purpose, control unit 20 records differential voltage 21 over a predefined time interval 31 in order to form a differential voltage profile, in particular a sinusoidal differential voltage profile. The differential voltage profile is then converted using a regression model across voltage maxima 32, in particular an envelope detector, into an envelope 33. One or more properties of the envelope 33, such as a present gradient, are determined and a command point in time 34 to 34′ is determined, based on the one or more properties and information about grid switching device 17 and further relevant elements in the control current circuit, i.e. pull-in time 30 until the operating contacts close, for transmitting a switch-on command to grid switching device 17 at which differential voltage 21 is below limit value 35 after pull-in time 30 has elapsed.

This results in a significantly larger time frame for the connection.

The connection algorithm verifies the following cyclically:
whether the current frequency is within a permitted tolerance around the grid frequency,
whether the present frequency is outside a dead band around the grid frequency,
whether the present frequency is increasing, and
whether a value of envelope 33 is below a maximum permitted limit value 35 after pull-in time 30 of grid switching device 17 and other relevant elements in the control current circuit has elapsed.

If all the conditions are met, the output of control unit 20 for switching on grid switching device 17 is activated. After pull-in time 30 has elapsed, its operating contacts are closed and asynchronous machine 5 is connected to power grid 11.

### III. GU Grid Disconnection

Furthermore, control unit 20 is configured to connect brake resistances 14 once or several times to asynchronous machine 5 based on the measured GU voltage when GU 1 is disconnected from power grid 11, in particular in the event of an emergency shutdown of GU 1. For this purpose, control unit 20 compares the measured GU voltage to a limit value and connects brake resistances 14 at a point in time at which the measured GU voltage exceeds a limit value, or at a point in time when the measured GU voltage drops below a limit value. In other embodiments, a two-level controller can be used.

When electrical energy is fed into a power grid, rotating asynchronous machine 5 is braked by power grid 11. The rotor of asynchronous machine 5 is driven by the mechanical power from the upstream process, e.g. the enthalpy of the work fluid mass flow of the ORC process via expansion machine 7. Expansion machine 7 attempts to accelerate asynchronous machine 5. However, the stator of asynchronous machine 5 generates a rotating field which is dependent on the power grid frequency in fixed manner and which, taking into account the slip, holds the rotor of asynchronous machine 5 in place. Assuming a lossless system, the mechanical force of expansion machine 7 opposes the electromagnetic force of the current from power grid 11.

If asynchronous machine 5 is disconnected from power grid 11, the electromagnetic force is eliminated. A distinction can be made between two load cases:
a) ORC machine 2 is shut down by reducing its input power. At minimum asynchronous machine power, the grid switching device is opened. The remaining energy from the upstream process is so low that the rotor is only slightly accelerated after disconnection of the power grid. A small overvoltage is excited by the capacitance; or
b) asynchronous machine 5 experiences an emergency shutdown or a power failure under full load. The rotor of asynchronous machine 5 is greatly accelerated. Asynchronous machine 5 and connected expansion machine 7 or the turbine can be mechanically overloaded. A high overvoltage can be excited by the capacitance.

In order to counteract this efficiently, brake resistances 14 are employed. They close a circuit with the capacitor-excited asynchronous machine 5. The current flowing in the stator of asynchronous machine 5 generates a magnetic field which flows through the windings or the cage, respectively, of the rotor of asynchronous machine 5 and brakes the machine.

In this case, moments can occur in asynchronous machine 5 only if there is a speed difference, i.e. a slip, between the rotor and the stator, because only then do temporal changes in the magnetic flux take effect, which leads to an induction.

Brake resistances 14 are sized such that they can convert the electrical energy into thermal energy without damage in the event of an emergency shutdown or a power failure under full load.

In order to not permanently energize brake resistances 14 in the state of GU 1 when connected to the grid, brake resistance switching device 15 is disposed upstream thereof. It is closed only when the grid switching device 17 is open. Since the capacitor-excited asynchronous machine 5, which is then disconnected from the power grid, represents a source whose voltage drops under load, there is a risk of partial loss of excitation when brake resistances 14 are switched on, which is associated with a partial loss of braking power, according to

deltaP_Brems(brake)=3*(deltaU_Erregung (excitation)\hat{ }2/R_Brems(brake)

in a three-phase circuit assuming the strand sizes.

Furthermore, part of the residual energy is dissipated from the ORC, which reduces the rotational speed and frequency. The excited voltage also decreases due to the resulting deteriorated resonant circuit behavior. A further condition for switching on the brake resistances is therefore the presence of a minimum excitation voltage. Brake resistances 14 can therewith be switched on and off several times during a braking operation. The schematic sequence during the braking process is as follows:
a) GU 1 is disconnected from power grid 11, voltage is high and rising,
b) brake resistances 14 are switched on,
c) voltage drops due to resistive load and falling frequency,
d) brake resistances are switched off,
e) voltage increases due to lacking load and frequency increase (residual energy from the ORC is still available),
f) brake resistances are switched on again and
g) back to step c).

To maintain maximum safety, brake resistance switching device 15 is actively switched off so that it is closed when the control device fails.

### IV. GU with an Internal Combustion Engine and an ORC Machine for Utilizing the Waste Heat from the Internal Combustion Engine

FIG. 4 shows a schematic structure of a GU 36 according to a second embodiment of the invention. In addition to the components of the first embodiment according to FIG. 1, GU35 furthermore comprises an internal combustion engine 37, the waste heat of which is utilized by an OCR machine 38.

In addition to first heat transferrer 6 (vaporizer), ORC machine 38 comprises a second heat transferrer 39 (preheater). Both heat transferrers 6, 39 are each connected via a heat transfer medium circuit with a pump 40, 41 to an exhaust gas heat transferrer 43, 42 for transferring heat from an exhaust gas flow 44 of internal combustion engine 37. ORC machine 38 also comprises a third heat transferrer 45 for transferring heat from a coolant of internal combustion engine 37. Also shown in FIG. 4 is the cooling circuit coupled to internal combustion engine 37 with an engine radiator 46 from which the heat of the coolant is branched off via third heat transferrer 45 and a pump 47. ORC machine 38 further comprises a condenser 8 which is part of a cooling circuit with a radiator 48 (e.g. an air cooler) and a coolant pump 49. Alternatively, condenser 8 can also give off the heat directly to the air, as shown in GU 1 according to FIG. 1.

In one embodiment, GU 36 is supplemented by an electric generator 50 which is driven by internal combustion engine 37 for generating electricity. Its electrical energy can be fed into the power grid via a frequency converter or via a direct connection (not shown).

### V. GS

FIG. 5 shows a schematic structure of a generating system, GS 51, which comprises a plurality of GUs 52 . . . 54, where one or more of GUs 53, 54 corresponds to GU 1 in FIG. 1 or to GU 36 in FIG. 4. As shown in FIG. 5, the electrical energy provided by GUs 52 . . . 54 can be fed via transformers 55 . . . 57 at a grid connection point into the public power grid 58, in particular a medium-voltage grid with 20 kV or a different voltage level in this range, or into a ship's electrical system.

GUs 52 . . . 54 can each be connected to the low-voltage side of a respective transformer 55 . . . 57.

### VI. Protective Mechanisms

In order to be able to carry out all the above-mentioned functions of GU 1 reliably at all times, the following checks are carried out:
checking the power grid voltage and generator voltage for direction of rotation,
checking the power grid voltage and generator voltage for symmetry,
monitoring for overfrequency to detect faulty controller settings (P, I, D),
checking excitation.
prior to each start-up process: checking the value of the brake resistance 14,
with each connection process: evaluating the possible aging-related pull-in time 30 of grid switching device 17 and other relevant elements in the control current circuit and storing them for the next switching process,
if the last connection process and thus the last measured value of the pull-in time 30 is too far in the past: carrying out a “dry connection” without voltage before starting up the machine to determine the exact value and
Checking the important switching devices (grid switching device 17, brake resistance switching device 15, main switch, brake resistance measuring contactor), preferably checking for feedback within a certain time.

### VII. Configuration of the Capacitors

A conventional asynchronous machine can be operated as a self-excited asynchronous generator. The procedure is described, for example, in the textbook “Elektrische Maschinen (Electrical Machines)”, edition: 17, Rolf Fischer, 2017.

A drivable machine shaft is advantageous for the configuration of capacitors 13 so that the machine can be operated with its number of poles p according to the synchronous rotational speed n_sync, according to

n_sync=2*f*60s/(2*p*1min).

The current flowing in power grid 11 is a pure magnetizing current, it is measured and the necessary capacitor capacity is calculated from this. Measuring this current could theoretically be carried out when a hermetically sealed air conditioning compressor is motor-operated, but this fails due to the fact that an air conditioning compressor can only be operated with fluid and the lubricant it contains. However, with an internally mechanically firmly coupled compressor and fluid this is already a mechanical load and therefore no longer represents idling operation. Operation of the hermetically sealed air conditioning compressor without fluid and without lubricant can destroy the machine. Even operation with the wrong direction of rotation, which cannot be seen from the outside, can unintentionally destroy the machine.

For these reasons, the following explanations of the configuration of capacitors 13 for excitation are subject to the special features of an electrical machine, which is accommodated together with thermodynamic expansion machine 7 in the same housing.

The values of the equivalent circuit diagram can typically be obtained from the manufacturer of the electrical machine. For idling, i. e. slip s=0, there is no magnetic connection and no rotor circuit. As a result, the no-load current, which corresponds only to the pure magnetizing current I_u, can be simply calculated according to

I_u=U/(R_s+2*Pi*f*L_s)

and is the voltage divided by the impedance from the effective stator resistance Rs and the (frequency-dependent) stator reactance 2*Pi*f*L_s.

Three-phase power capacitors available on the market are typically delta-connected internally. The required capacitor size can be calculated according to

C=I_u/(sqrt(3)*2*Pi*f*U).

The calculation shown represents the rough configuration of the excitation capacitance. A configuration start value for the fine configuration is determined therefrom—this already arises from the fact that the nominal sizes of the capacitors available on the market are only available in a certain granularity—in order to then determine the reliably operating and procurable capacitance by way of a heuristic approach:
a) accelerating and maintaining the generator at a specific rotational speed by varying the feed pump rotational speed or by using the generator rotational speed controller,
b) measuring the excited actual voltage and comparing it with the expected target voltage,
c1) If the deviation is too great: shutting down, correcting the capacitance, then a)
c2) If the deviation is within the defined tolerance: finished or a) with further rotational speed. The result is a capacitance that, under the real conditions—line lengths, line routing, measurement inaccuracies in the rough configuration, etc.—certainly excites a voltage that leads to successful synchronization at grids with the expected frequency and voltage parameters.

### VIII. Advantages of the Invention

simple,
secure,
inexpensive
easily obtainable parts,
high degree of efficiency,
grid compatible,
small space requirement, and
low heat development

1. A generating unit, GU, comprising:
an asynchronous machine with a connecting branch for direct grid connection to a power grid;
an energy converter that operates according to a thermodynamic or fluiddynamic process, in particular a thermodynamic cycle process, and thus drives said asynchronous machine for generating electricity, and
an excitation component,
where said excitation component is formed from capacitors that are connected to said asynchronous machine.

2. The GU according to claim 1, where said energy converter is a Rankine Cycle machine, preferably an Organic Rankine Cycle machine, with an expansion engine, where said expansion engine is coupled mechanically to a shaft of said asynchronous machine, and where said Rankine Cycle machine is supplied with heat output, in particular waste heat, to drive said expansion engine.

3. The GU according to claim 2, where said asynchronous machine is integrated into said expansion engine and is preferably a three-phase asynchronous machine with a short circuit rotor or squirrel-cage rotor.

4. The GU according to claim 3, where said expansion machine and said asynchronous machine are housed in a closable, i.e., semi-hermetic housing with one or more steam connections, in particular a steam inlet for live steam and a steam outlet for waste steam, and an electrical connection.

5. The GU according to claim 1, where said asynchronous machine has a rated power of between 50 and 5000 kW.

6. The GU according to claim 1, where said capacitors are star-connected or delta-connected.

7. The GU according to claim 1, where said GU comprises brake resistances which are connected to said asynchronous machine via a brake resistance switching device.

8. The GU according to claim 7, where said brake resistance switching device comprises operating contacts for connecting said brake resistances to said asynchronous machine or to disconnect said brake resistances from said asynchronous machine, respectively, where said operating contacts are closing operating contacts for actively switching on said brake resistances or opening operating contacts for actively switching off said brake resistances in order to securely brake said rotor of said asynchronous machine in the event of a failure of the control device such as a failure of the control voltage supply.

9. The GU according to one of the claims 7, where said GU comprises a control unit for controlling said brake resistor switching device which is configured to connect said brake resistances once or several times to said asynchronous machine based on a measured GU voltage when said GU is disconnected from said power grid, in particular in the event of an emergency shutdown of said GU.

10. The GU according to claim 1, where said GU comprises a grid switching device for connecting or disconnecting said GU to/from said power grid, and a control unit for controlling said grid switching device,
where said control unit is configured to connect said asynchronous machine synchronously to said power grid, preferably in that said control unit forms a differential voltage based on a measured grid voltage and a measured GU voltage and, based on this, connects said grid switching device below a limit value of said differential voltage, preferably at a voltage magnitude between 0 V and 150 V.

11. The GU according to claim 10, where said control unit is configured to record said differential voltage over a time interval for synchronizing the connection in order to form a differential voltage profile, in particular a sinusoidal differential voltage profile, and to convert the differential voltage profile to an envelope, preferably using a regression model via the voltage maxima, in particular an envelope detector, to determine one or more properties of said envelope, such as a present gradient of said envelope and to determine a command point in time, based on the one or more properties and information about said grid switching device, in particular its pull-in time for closing its operating contacts, for transmitting a switch-on command to said grid switching device, at which said differential voltage is below said limit value after said pull-in time has elapsed, and to sends said switch-on command to said grid switching device at said determined command point in time.

12. The GU according to claim 10, where said energy converter comprises an expansion machine and a vaporizer capable of vaporizing a work fluid with the heat output supplied and directs it into said expansion machine for conversion to mechanical power, and a feed pump, the rotational speed of which can be controlled and which is configured to obtain the work fluid from said expansion machine, preferably from a condenser for liquefaction connected therebetween, and to convey it back to said vaporizer, where said control unit is configured to regulate or control the rotational speed of said feed pump, with which the pressure ratio of live steam is adjusted in relation to the pressure in said condenser, so that the rotational speed of said expansion machine is made to match the grid frequency or the grid rotational speed of said power grid.

13. The GU according to claim 1, where said GU comprises a second energy converter, where said second energy converter generates waste heat which said first energy converter is supplied with for generating electricity.

14. The GU according to claim 13, where said GU comprises an electrical generator, where said second energy converter is configured to drive said electrical generator.

15. A generating system, GS, with at least one GU according to claim 1, where said GS is connected to a power grid, in particular a public power grid on land or a ship electrical system, for generating electricity.
